(19) United States
(12) Patent Application Publication
(10) Pub. No.: US 2013/0098212 A1
(43) Pub. Date: Apr. 25, 2013

(54) TELESCOPIC EXTENSION DEVICE FOR A HANDLE OF A WRENCH

(71) Applicants: David INGERSOLL, Grant, MI (US); Rusty Vanas, Grant, MI (US)

(72) Inventors: David INGERSOLL, Grant, MI (US); Rusty Vanas, Grant, MI (US)

(21) Appl. No.: 13/280,337

(22) Filed: Oct. 24, 2011

(51) Int. Cl. B25G 1/04; B25B 23/16

(52) U.S. Cl. 81/177.2

(57) ABSTRACT

A telescopic extension device for a handle of a wrench includes three sliding overlapping concentric tubular members. A mechanism is for retaining the three tubular members in an extended position. When the three tubular members are in the extended position, the handle of the wrench will snugly fit into a front end of the first tubular member having the smallest diameter, so as to help increase the amount of torque applied by a person using the wrench to either loosen and tighten a nut and bolt.

### BACKGROUND OF THE INVENTION

1. Field of the Invention

The present invention relates to a tool handle extender, and more particularly, a telescopic extension device for a handle of a wrench.

The present invention is a tool configured to provide additional force and leverage when removing a nut or bolt with a conventional wrench, such as a ratchet wrench. The telescopic extension device can be used by mechanics, machinists, farmers, and anyone else that needs to loosen or tighten a nut or bolt.

The present invention is used in conjunction with the conventional wrench to extend the length of the handle of the wrench to augment leverage and increase the amount of torque applied. The telescopic extension device provides convenience and practicality to all users.

2. Description of the Prior Art

Small wrenches are not sufficient in length to produce the adequate amount of torque needed to loosen or tighten a nut or bolt. A common solution is to employ the use of two wrenches intertwined together in order to achieve additional torque. It is not unusual for one of these wrenches to break, resulting in an added expense and even injury. A more reliable option is needed.

Numerous innovations for auxiliary wrench leverage bars have been provided in the prior art that will be described. Even though these innovations may be suitable for the specific individual purposes to which they address, however, they differ from the present invention.

A FIRST EXAMPLE, U.S. Pat. No. 2,605,665, Issued on Aug. 5, 1952, to Grenat teaches a wrench adapted for use as an auxiliary handle for other wrenches or tools and comprising a handle, spaced externally polygonal laterally projecting jaw members at one end of the handle, and an externally polygonal laterally projecting jaw member disposed on the handle inwardly from the jaws and intermediate thereof, the jaw members being of relatively graduated diameters whereby the jaw members may be engaged directly with work, or a jaw member may be individually engaged with the jaw of a wrench having jaws at each end thereof in selected angular relation to such wrench to provide an auxiliary handle therefore, or the intermediate jaw member may be engaged with the jaw of a wrench with its handle in supported levering engagement with one of the spaced jaw members to provide an auxiliary handle for the wrench so engaged, or the handle of a tool may be engaged between the intermediate jaw member and one of the spaced jaw members to provide an auxiliary handle therefor.

A SECOND EXAMPLE, U.S. Pat. No. 3,376,768, Issued on Apr. 9, 1968, to Fortunato teaches a linkage bar for wrenches and more particularly with a linkage bar connectable between a pair of wrenches at least one of which is a double-headed end wrench. The linkage bar is provided with a pair of stud-like projections having flat perimetrical faces defining a polygon and the other stud-like projection having flat perimetrical faces also defining a polygon, but the flat faces of one stud-like projection being disposed at different angles relative to the bar axis than that of the other.

A THIRD EXAMPLE, U.S. Pat. No. 4,811,638, Issued on Mar. 14, 1989, to Kertzscher teaches a tool for use in tightening or removing a fastener that requires greater torque than the user can generate through application of hand force on the handle of the tool with the handle of the tool having sufficient length for a user to grasp in the user's hand as the user tightens or removes a fastener. The handle of the tool having a head with jaws for engaging a fastener to tighten or remove the fastener and a second end on the opposite end of the handle having a square opening to receive a drive mechanism to permit the user to increase the torque on a fastener by providing a longer lever to thereby permit the user to increase the torque on the fastener without the user having to increase the hand force.

A FOURTH EXAMPLE, U.S. Pat. No. 4,905,548, Issued on Mar. 6, 1990, to Colace et al. teaches an adjustable extension that is designed for being employed with ratchet and hinge handle wrenches, and takes the place of different fixed length extensions for these wrenches. Primarily, it consists of telescoping members that are coupled together by knurled locking collars with O-rings. One end fits the drive end of a wrench and the other end is designed to be received in typical sockets that engage with nuts or bolts.

A FIFTH EXAMPLE, U.S. Pat. No. 5,570,617, Issued on Nov. 5, 1996, to Love teaches an extendible extension handle that can be used with wrenches, ratchets, tire iron and such to permit the user to increase the leverage applied to the tool. The inner handle assembly is the base to engage the handle at one end and the tools at the opposite end. The tool end of the inner handle assembly has first and second openings in its upper base to engage the handle portion and closed end portion of wrenches and an opening on bottom base to engage opening end wrenches. The inner handle assembly being tubular in structure allows for ratchets, tire iron and such to easily be inserted into the base. It fits around the inner handle assembly tool end and has an opening down its shaft to engage the wrench. Once the wrench has been engage the stabilizer can be aligned to a locking position which will allow the user to adjust the tension on the stabilizer clamping mechanism. The stabilizer assembly mobility is limited to a circular rotation by fixed bushings attached to the inner handle assembly. The outer handle assembly is telescoped with an L shape groove down portion of its length and a latching mechanism for various adjustments.

A SIXTH EXAMPLE, U.S. Patent Office Document No. 5,927,161, Issued on Jul. 27, 1999, to Clifford et al. teaches an adjustable tool with multiple telescoping units. The upper member has a closed upper end, an open lower end, and a cylindrical sidewall therebetween. The closed upper end has a recess formed for receiving a drive end of a ratchet. An interior surface of the cylindrical wall has a plurality of diametrically opposed recesses extending a length. An intermediate member is telescopically received within the open lower end of the upper member. The intermediate member has an upper portion and a lower portion. The upper portion has a thickness less than a thickness of an interior of the upper member. The upper portion has a pair of diametrically opposed spring balls extending outwardly for selectively mating with a pair of recesses of the upper member. The lower portion has an open lower end and a hollow interior. An interior surface of the lower portion has a plurality of diametrically opposed recesses extending a length. A lower member is telescopically received within the open lower end of the lower portion of the intermediate member. The lower member has an upper portion with a thickness less than a thickness of an interior of the lower portion of the intermediate member. The upper portion has a pair of diametrically opposed spring balls extending outwardly for selectively mating with a pair of opposed recesses of the lower portion. A lower end of the lower member has a drive end.

A SEVENTH EXAMPLE, U.S. Pat. No. D422,193, Issued on Apr. 4, 2000, to Walker teaches an ornamental design for a tool handle extension, as shown and described.

AN EIGHTH EXAMPLE, U.S. Pat. No. D432,890, Issued on Oct. 31, 2000, to Webb teaches an ornamental design for a wrench extension, as shown and described.

A NINTH EXAMPLE, U.S. Patent Office Publication No. 2003/0033911, Published on Feb. 20, 2003, to Averett et al. teaches a Lug Nut Buster™, that is an adapter used for the removal of over tightens automobile tire lug nuts. It is painted 30-inch galvanized steel pipe. The center of the bar is hollow enabling it to fit over the standard lug wrench. The diameter is of the bar is ½ inch. The tool uses the principal of leverage to enable individual to loosen any lug nut. On one end of the bar is a 4¾ inch black gel grip.

A TENTH EXAMPLE, U.S. Patent Office Publication No. 2004/055428, Published on Mar. 25, 2004, to Cooper teaches a leverage assembly in combination with an elongated hand tool. The hand tool has a first end adapted for engaging an object and a second end opposite the first end. The leverage assembly includes an adapter bar having first and second ends. A U-bolt attaches the first end of the adapter bar to the second end of the hand tool. A leverage bar engages the second end of the adapter bar. A receptacle is formed with the adapter bar for receiving the leverage bar. The leverage bar, adapter bar, and hand tool cooperate to multiply a force applied by the user to the object to manipulate the object.

A ELEVENTH EXAMPLE, U.S. Patent Office Publication No. 2004/0200325, Published on Oct. 14, 2004, to Huffman teaches an extension handle for increasing the leverage of wrenches which comprises an elongated member having a side, a length and opposite first and second ends, the first end being adapted to form a handle, and the second end having an elongated slot extending along the side of the member. The slot extends from the second end to a first point towards the handle and the slot has a bottom. The bottom of the slot has an elongated aperture positioned between the second end and the first point. The aperture is dimensioned and configured to permit one of the bifurcated ends of the wrench to pass through the aperture.

A TWELFTH EXAMPLE, U.S. Patent Office Publication No. 2005/0183550, Published on Aug. 25, 2005, to Day teaches a wrench extension device which includes an elongate handle with oppositely directly cusps positioned near one end for engaging the medial portion of a hand wrench and extending its effective length for achieving greater torque on any nut, bolt, etc. with which the wrench is engaged.

A THIRTEENTH EXAMPLE, U.S. Patent Office Publication No. 2006/0156870, Published on Jul. 20, 2006, to Vachon teaches an extension bar having at one end a generally L-shaped form of a handle, and at the opposite end of the extension bar a headblock is formed therefor receiving a wrench head, and a head portion with notches is formed thereon for receiving one of both indented openings formed thereupon top surface of an adapter being configured therefor receiving a straight wrench, and which is capable of rotating to allow the wrench to loosen or tighten nuts or bolts head in locations where are difficult to reach with the wrench.

It is apparent now that numerous innovations for auxiliary wrench leverage bars have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a telescopic extension device for a handle of a wrench that avoids the disadvantages of the prior art.

ANOTHER OBJECT of the present invention is to provide a telescopic extension device for a handle of a wrench that is simple and inexpensive to manufacture.

STILL ANOTHER OBJECT of the present invention is to provide a telescopic extension device for a handle of a wrench that is simple to use.

BRIEFLY STATED, STILL YET ANOTHER OBJECT of the present invention is to provide a telescopic extension device for a handle of a wrench comprises three sliding overlapping concentric tubular members. A mechanism is for retaining the three tubular members in an extended position. When the three tubular members are in the extended position, the handle of the wrench will snugly fit into a front end of the first tubular member having the smallest diameter, so as to help increase the amount of torque applied by a person using the wrench to either loosen and tighten a nut and bolt.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing the present invention in use;

FIG. 2 is an enlarged perspective view showing the present invention in the extended position with the handle of the wrench installed thereto;

FIG. 3 is an enlarged perspective view showing the present invention per se in the collapsed position; and

FIG. 4 is an enlarged exploded perspective view showing the various components of the present invention separated.

### REFERENCE NUMERALS UTILIZED IN THE DRAWING

110 telescopic extension device
112 handle of wrench 114
114 wrench
116 first tubular member of device 110
118 second tubular member of device 110
120 third tubular member of device 110
122 retaining mechanism of device 110
124 front end of first tubular member 116
126 person
128 stainless steel
130 first ball plunger of retaining mechanism 122
132 back end of first tubular member 116
134 second ball plunger of retaining mechanism 122
136 back end of second tubular member 118
138 first aperture of retaining mechanism 122
140 front end of second tubular member 118
142 second aperture of retaining mechanism 122
144 front end of third tubular member 120

### DETAILED DESCRIPTION OF THE PREFERRED EMBODIMENT

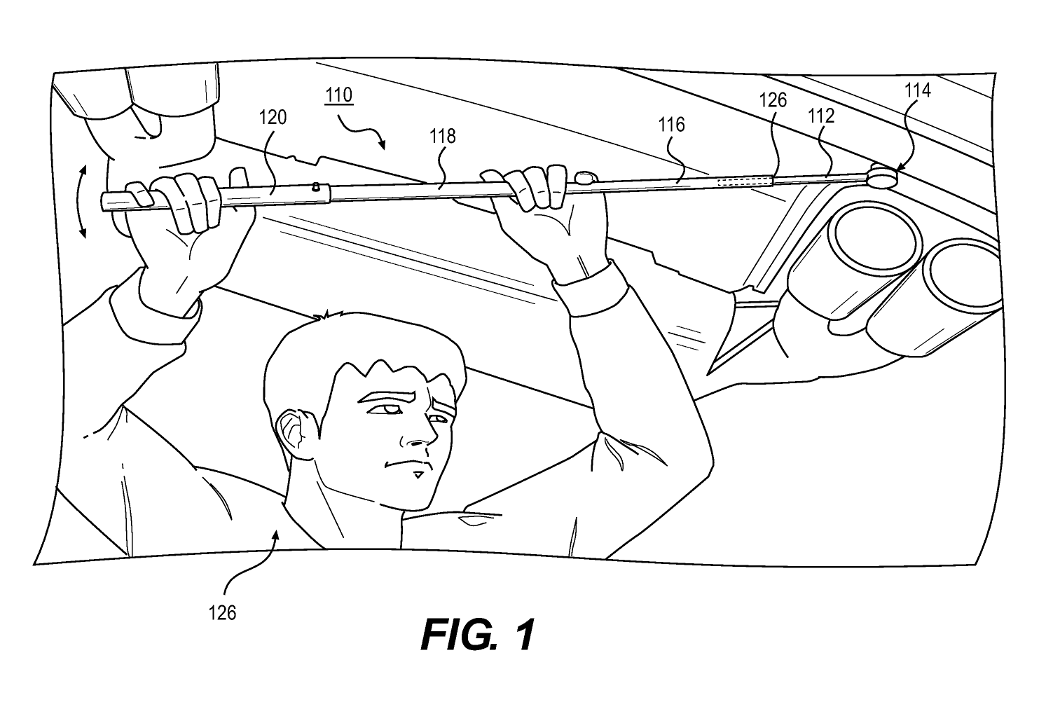

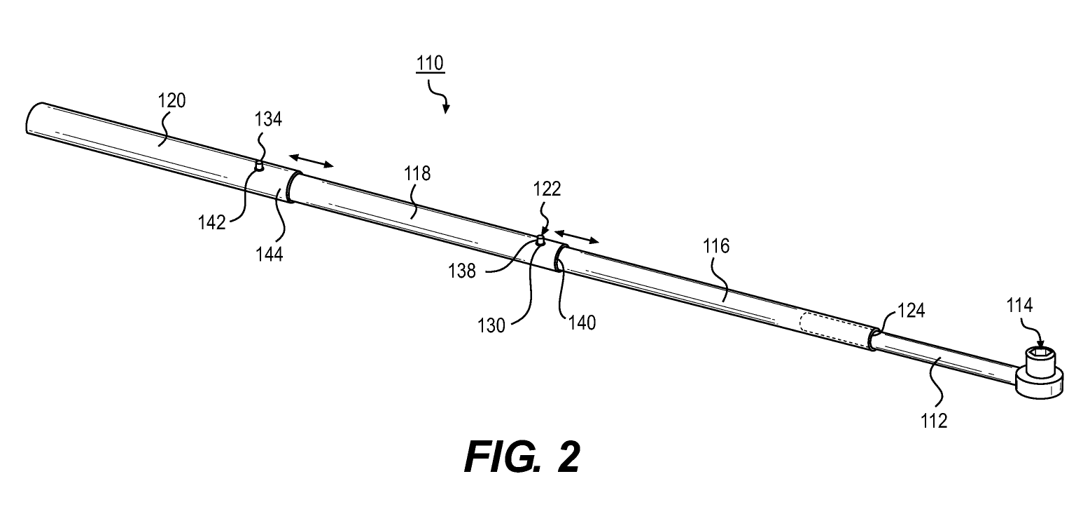

In FIG. 1, a telescopic extension device 110 is for a handle 112 of a wrench 114 which comprises three sliding overlapping concentric tubular members 116, 118 and 120. A mechanism 122 is for retaining the three tubular members 116, 118 and 120 in an extended position, shown in FIGS. 1 and 2. When the three tubular members 116, 118 and 120 are in the extended position the handle 112 of the wrench 114 will snugly fit into a front end 124 of the first tubular member 116 having the smallest diameter, so as to help increase the amount of torque applied by a person 126 using the wrench 114 to either loosen and tighten a nut and bolt.

In FIG. 2, the three tubular members 116, 118 and 120 can extend approximately from twelve to twenty four inches in length and then again to thirty three inches in length to give out a minimum, medium and maximum additional torque accordingly. The first tubular member 116 having the smallest diameter and can be approximately three quarters of an inch to one and one quarter of an inch in diameter to accommodate different sized handles 112 of the wrench 114. The three tubular members 116, 118 and 120 are comprised out of a strong durable material, such as stainless steel 120. There is a layer of grease between each tubular members for the purpose of sliding in and out easily.

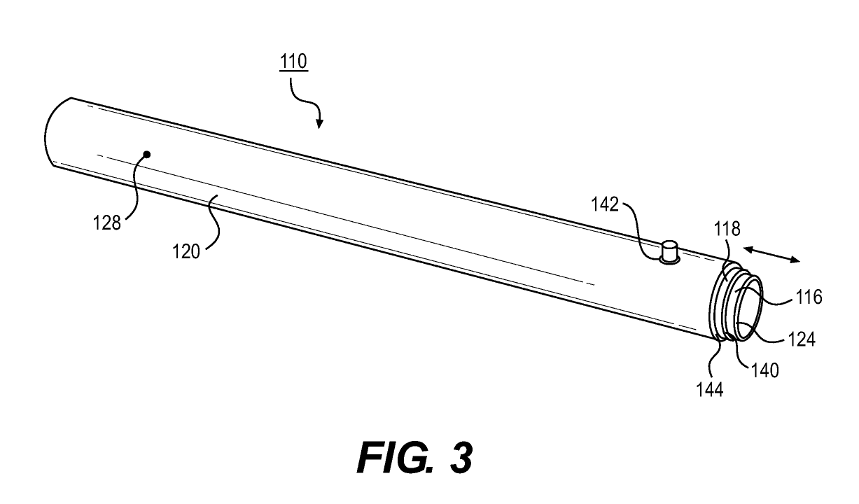

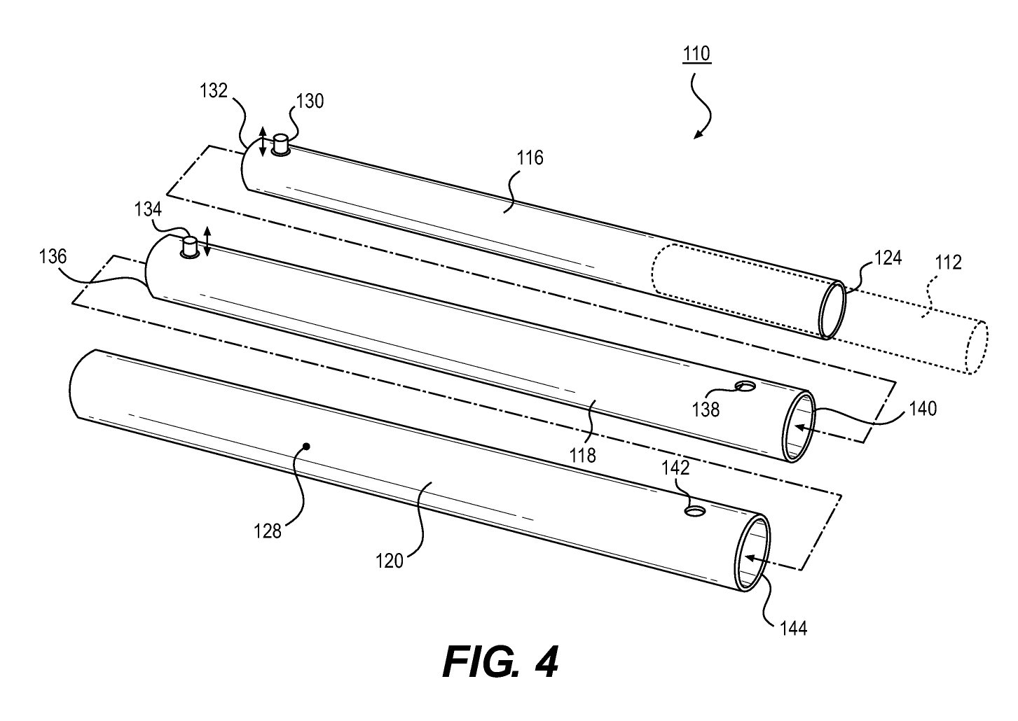

In FIG. 3, the retaining mechanism 122 comprises the first tubular member 116 containing a first ball plunger 130 located near a back end 132. The second tubular member 118 contains a second ball plunger 134 located near a back end 136 and has an aperture 138 located near a front end 140. The third tubular member 120 has an aperture 142 located near a front end 144. In a first instance, the ball plunger 130, 134 will engage with the apertures 138, 142 when the three tubular members 116, 118, 120 are in the extended position. In a second instance, the ball plungers 130, 134 can be manually depressed to disengage with apertures 138, 142 to allow the three tubular members 116, 118 and 120 to go into a collapsed position (as in FIG. 3) and if necessary be separated for easy storage (as in FIG. 4).

In FIG. 4, the device 110 can be detached to separate all three tubular members 116, 118 and 120 depending on use. There is a retaining mechanism 122 having ball plungers 130, 134 and apertures 138, 142 installed in the tubular members 116, 118 and 120 to stop the extension thereof. The device 110 can collapse to easily store in a drawer, toolbox, under a vehicle seat, in a trunk, etc. The device 110 is used in conjunction with a handle 112 of a wrench 114, such as a ratchet wrench or other type of wrench. The handle 112 is inserted into the first tubular member 116 for use.

In review, the telescopic extension device 110 is configured to make the process of loosening or tightening a nut or bolt easier. The present invention consists of three tubular members 116, 118 and 120 that telescopes from twelve to thirty-three inches in length.

The device 110 may be made out of a stainless steel 128 or other suitable material. The diameter of the first tubular member 116 may range from three quarters to one quarter of an inch to accommodate different sized handles 112. The exact specifications may vary.

It will be understood that each of the elements described above, or two or more together, may also find a useful application in other types of constructions differing from the types described above.

While the invention has been illustrated and described as embodiments of a telescopic extension device for a handle of a wrench, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A telescopic extension device for a handle of a wrench which comprises:
a) three sliding overlapping concentric tubular members; and
b) means for retaining the three tubular members in an extended position, whereby when the three tubular members are in the extended position the handle of the wrench will snugly fit into a front end of the first tubular member having the smallest diameter, so as to help increase the amount of torque applied by a person using the wrench to either loosen and tighten a nut and bolt.

2. The device as recited in claim 1, wherein the three tubular members can extend approximately from twelve to twenty four inches in length and then again to thirty three inches in length to give out a minimum, medium and maximum additional torque accordingly.

3. The device as recited in claim 1, wherein the first tubular member having the smallest diameter and can be approximately three quarters of an inch to one and one quarter of an inch in diameter to accommodate different sized handles of the wrench.

4. The device as recited in claim 1, wherein the three tubular members are comprised out of a strong durable material.

5. The device as recited in claim 4, wherein the strong durable material is stainless steel.

6. The device as recited in claim 1, wherein the retaining means comprises:
a) the first tubular member containing a first ball plunger located near a back end;
b) the second tubular member containing a second ball plunger located near a back end and having a first aperture located near a front end; and
c) the third tubular member having a second aperture located near a front end, whereby in a first instance the ball plungers will engage with the apertures when the three tubular members are in the extended position, while in a second instance the ball plungers can be manually depressed to disengage with the apertures to allow the three tubular members to go into a collapsed position and if necessary be separated for easy storage.

7. The device as recited in claim 1, further comprising a layer of grease among tubular members for the purpose of easy sliding in and out.
